(19) United States
(12) Patent Application Publication
(10) Pub. No.: US 2021/0090032 A1
(43) Pub. Date: Mar. 25, 2021

(54) TIME SLOTS GENERATIONS

(71) Applicant: Hewlett-Packard Development Company, L.P., Spring, TX (US)

(72) Inventors: Ronaldo Rod Ferreira, Porto Alegre (BR); Rodrigo Dias Correa, Porto Alegre (BR); Christopher Charles Mohrman, Houston, TX (US)

(73) Assignee: Hewlett-Packard Development Company, L.P., Spring, TX (US)

(21) Appl. No.: 16/603,606

(22) PCT Filed: Apr. 19, 2017
(86) PCT No.: PCT/US2017/028261

§ 371 Date: Oct. 8, 2019

(51) Int. Cl. G06Q 10/10; G06Q 10/06; H04W 4/021; H04L 12/58

(52) U.S. Cl. CPC G06Q 10/1095; G06Q 10/107; G06F 3/0484; H04W 4/021; H04L 51/28; G06Q 10/06311

(57) ABSTRACT

In example implementations, a method for generating a time slot in a meetings scheduling application and an apparatus for performing the same is provided. The method is performed by a processor of a device executing the meeting scheduling application. The method includes detecting a meeting time slot that is scheduled in a meeting scheduling application. A time period for a time slot is determined in response to detecting the meeting time slot that is scheduled. The time slot for the time period that is determined is generated. A graphical representation of the meeting time slot in the meeting scheduling application is modified to include the time slot for the time period that is determined adjacent to an end time of the meeting time slot.

### BACKGROUND

A meeting scheduling program may be used in enterprise environments to schedule meetings. The meeting scheduling program may be shared by co-workers to allow other users within an enterprise to see when co-workers are available and schedule meetings. An invitation may be sent to co-workers who are invited to attend a meeting and a time slot may be reserved in the scheduling program with the meeting and associated meeting details.

### BRIEF DESCRIPTION OF THE DRAWINGS

FIG. 1 is a block diagram of an example endpoint device that generates time slots in a meeting scheduling application of the present disclosure;

FIG. 2 is example screen shots of a graphical user interface of the meeting scheduling application that is modified with the time slots of the present disclosure;

FIG. 3 is an example email that is generated in response to a meeting overlapping with a time slot of the present disclosure;

FIG. 4 is a flow diagram of an example method for generating a time slot in a meeting scheduling application; and

FIG. 5 is an example non-transitory computer readable medium storing instructions executed by a processor to generate a time slot in a meeting scheduling application of the present disclosure.

### DETAILED DESCRIPTION

The present disclosure relates to a method for generating a time slot in a meeting scheduling program and an apparatus for performing the same. As discussed above, a meeting scheduling program may be used in enterprise environments to schedule meetings. Co-workers may book other co-workers for meetings in multiple consecutive time slots. As a result, an employee of the enterprise may have multiple consecutive meetings, or even meetings that overlap timeslots, with no breaks between the meetings.

Health monitoring has developed into a large industry for various aspects of an individual's life. For example, devices are created to monitor an individual's activity, sleep patterns, heart rate, and the like. However, when scheduling meetings within an enterprise environment, health of an employee is not taken into consideration.

Having multiple consecutive meetings without a break, or the ability to prepare the employee's mind properly for the next meeting, may create a stressful environment for the employee. The present disclosure provides examples of a meeting scheduling program that automatically inserts time slots between consecutive meetings. The time slots may provide wellness to users by automatically scheduling a break, or a moment to recompose themselves, before a subsequent meeting. The meeting scheduling program may automatically create the time slot and also adjust meeting times to account for the created time slot.

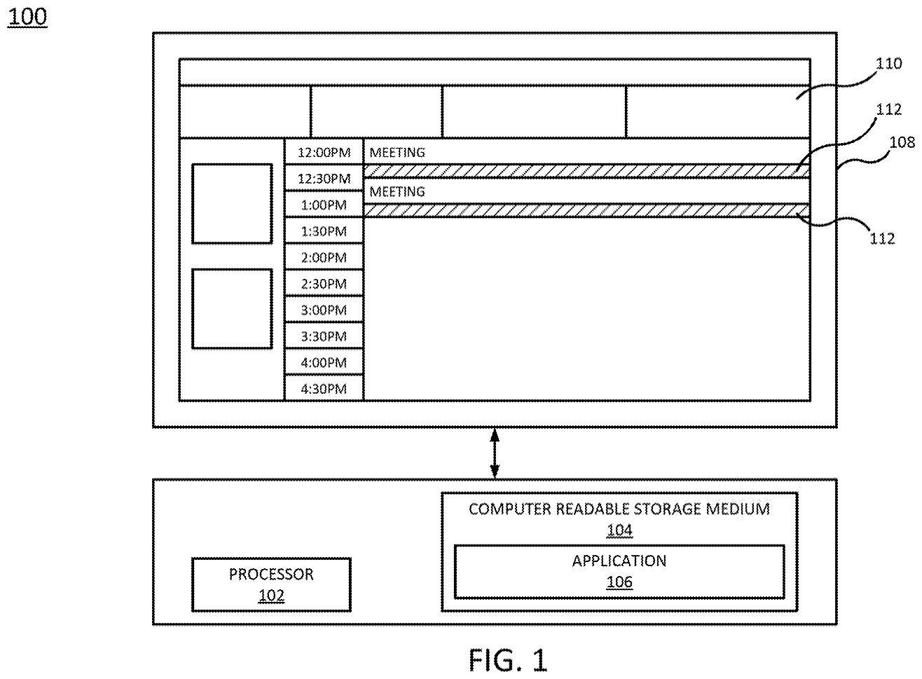

FIG. 1 illustrates a block diagram of an example endpoint device 100 that generates time slots 112 in a meeting scheduling application 106 of the present disclosure. The endpoint device 100 may be a computing device such as a desktop computer, a laptop computer, a tablet computer, and the like. In one implementation, the endpoint device 100 may include a processor 102, a computer readable storage medium 104 and a display 108. The processor 102 may be in communication with the computer readable storage medium 104 and the display 108.

In one implementation, the computer readable storage medium 104 may store instructions associated with the meeting scheduling application 106 that is executed by the processor 102. The meeting scheduling application 106 of the present disclosure may generate a graphical user interface (GUI) 110 on the display 108. The GUI 110 may display meeting scheduling tools such as a calendar, time slots for a selected day, meeting scheduler, and the like.

In one example, the meeting scheduling application 106 may automatically generate a time slot 112 that can be used to modify a graphical representation of a meeting time slot in the GUI 110. The meeting scheduling application 106 may generate any number of time slots 112 that can be used to modify any number of graphical representations of meeting time slots in the GUI 110.

The time slot 112 may also be referred to as a “wellness” time slot as the time slot 112 is intended to improve the health and wellness of an individual by automatically scheduling breaks in between consecutive meetings. In one example, the time slot 112 may be defined as a time slot that is automatically generated by the meeting scheduling application 106. In other words, the meeting scheduling application 106 initiates the generation of the time slot 112. Said another way, the time slot 112 is not generated in response to a meeting request created by a user, or in response to any particular dates or times detected in an email or other application.

Furthermore, the time slot 112 is unrelated to any other meeting time slots that are created or generated in the GUI 110. For example, the time slot 112 is not an extension of an existing meeting. The time slot 112 may be an independently created graphical element of the GUI 110.

In addition, the time slot 112 is not associated with a recipient or a meeting invitation. For example, the meeting time slots in the GUI 110 may be generated in response to an invitation from another user or a meeting created by a user via the meeting scheduling application 106. Moreover, the meeting time slots may be associated with recipients that may attend the meeting. In contrast, the time slot 112 is generated for the wellness, or well-being, of the user and is not associated with a recipient.

The time slot 112 may be generated automatically by the meeting scheduling application 106 in response to meetings that are schedule in consecutive time slots. For example, the time slot 112 may be generated automatically by the meeting scheduling application 106 to allow a user to have a short break between consecutive meetings. The short breaks may allow the user to be fresher, more prepared and more productive in meetings.

The graphical representations of the meeting time slots that are modified with the time slot 112 may be visible by other users. For example, the meeting scheduling application 106 may share the calendar of a user with other users when scheduling a meeting. The time slot 112 may prevent other users from scheduling consecutive meetings with the user.

In one implementation, meeting scheduling application 106 may determine that a time period of a proposed meeting of an invitation received from another user overlaps a time slot 112. In response, the meeting scheduling application 106 may generate a warning notification and transmit the warning notification to a device of a user that originated the invitation. For example, the warning notification may include an email message or a pop-up notification that indicates a time slot 112 is being violated. The warning notification may also instruct the other user attempting to schedule the proposed meeting to change the proposed start time, or provide a closest available start time of the invited user that does not overlap a time slot 112 of the invited user. As a result, the time slots 112 may prevent other users from scheduling consecutive meetings that could overwhelm a user.

In one example, the time slot 112 may be generated automatically by the meeting scheduling application 106 based on an historical late arrival time of a user or a predefined time period. In one example, the historical late arrival time may be a weighted average of the historical late arrival time to online meetings and the historical late arrival time to physical meetings. For example, the average historical late arrival time may be calculated according to the function:

WellnessSlotₕ=α*X+β*Y,

where WellnessSlotₕ is the average historical late arrival time of the user, X is the average late arrival time to online meetings, Y is the average late arrival time to physical meetings, and α and β are weighting parameters having a value between 0 and 1 where the sum of α and β equals 1. The weighting parameters may be set based on an importance of online meetings over physical meetings or vice versa. If the importance is equal, then the weighting parameters may be set to the same value (e.g., 0.5 and 0.5)

In one implementation, the historical late arrival time to online meetings may be logged, or tracked, by the endpoint device 100. For example, the endpoint device 100 may track a time that an online meeting was scheduled to begin via the meeting scheduling application 106 and a time that the user logs into the online meeting.

In one implementation, the historical late arrival time may be logged, or tracked, using a global positioning system (GPS), indoor positioning system, and the like. For example, the GPS system may be contained within a mobile endpoint device of a user or the employee's physical location may be tracked using the indoor positioning system. In one example, the mobile endpoint device may track a time that a user arrives at a location associated with a meeting scheduled in the meeting scheduling application 106. The times may be downloaded or transmitted to the endpoint device 100. The endpoint device 100 may then calculate the late arrival time based on the time the meeting was scheduled to begin and a time that the user arrived at the location associated with the meeting.

If the user is rarely late to meetings, the time slot 112 may be generated automatically based on a static amount of time (WellnessSlotₛ), or a predefined time period. In other words, the time slot 112 may be generated based on a larger value of the average historical late arrival time WellnessSlotₕ or the predefined time period WellnessSlotₛ.

In one example, a graphical representation of the time slot 112 in the GUI 110 may be based on the late arrival time value that is calculated and selected by the meeting scheduling application 106. For example, the amount of time that the width of the time slot 112 spans in the GUI 110 may be equivalent to the value of the late arrival time value that is calculated and selected.

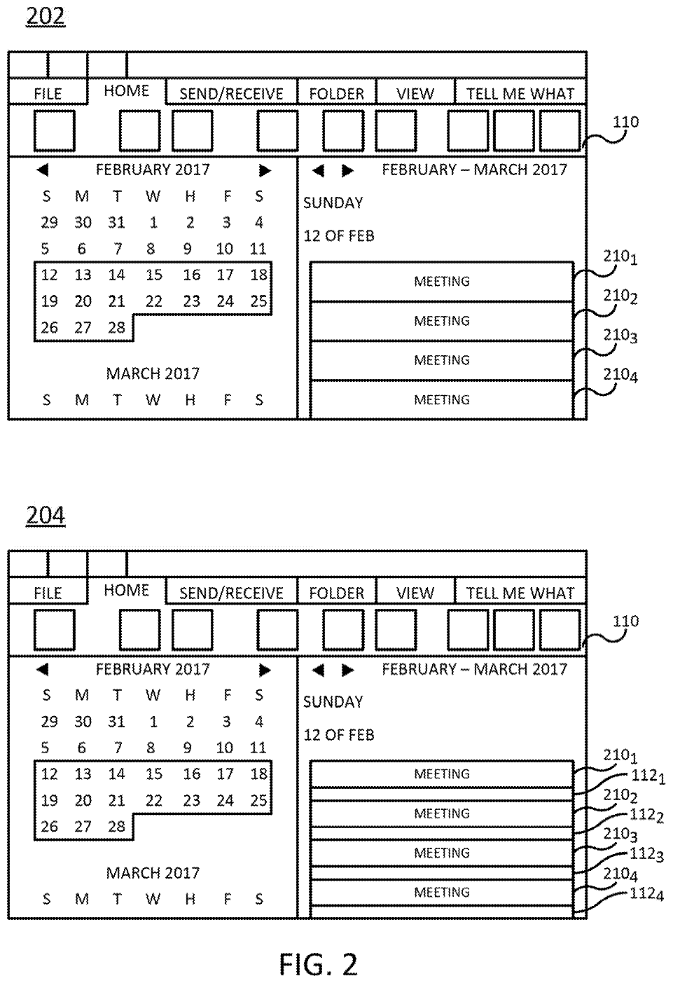

FIG. 2 illustrates example screen shots of the GUI 110 of the meeting scheduling application 106. For example, a screen shot 202 may illustrate the GUI 110 where a user has been scheduled for four consecutive meeting time slots 210₁ to 210₄. When the meeting scheduling application 106 detects consecutive meeting time slots 210₁ to 210₄, the meeting scheduling application 106 may automatically generate time slots 112.

For example, a screen shot 204 may illustrate the GUI 110 where the meeting time slots 210₁ to 210₄ have been modified with the time slots 112₁ to 112₄. The time slots 112₁ to 112₄ may be located adjacent to an end time of a corresponding time slot 210₁ to 210₄.

In one example, the amount of time used for the time slots 112₁ to 112₄may be based on the larger value of the average historical late arrival time or the predefined time period, as discussed above. Notably, the user does not create the time slots 112₁ to 112₄. Rather, the time slots 112₁ to 112₄ are generated automatically by the meeting scheduling application 106 in response to detecting consecutive meeting time slots 210₁ to 210₄.

In one example, the time slots 112₁ to 112₄ may have a different graphical representation than the meeting time slots 210₁ to 210₄. For example, the time slots 112₁ to 112₄ may be a different color, a different filling (e.g., hash marks. slashes, checkered shapes, and the like, inside the slot) than the meeting time slots 210₁ to 210₄.

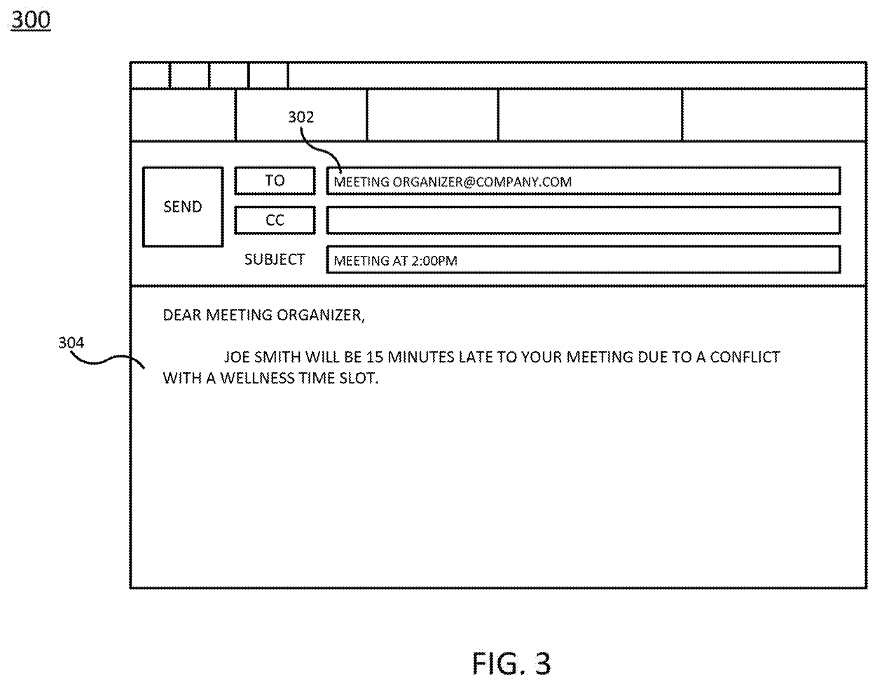

FIG. 3 illustrates an example email 300 that may be generated in response to a meeting overlapping with a time slot 112. For example, referring back to FIG. 2, the meeting time slots 210₁ and 210₂ may have been scheduled at the same time or at approximately the same time. The meeting scheduling application 106 may detect that the meeting time slot 210₁ and 210₂ are consecutive with no time for a break in between the meetings. In response to the consecutive meeting time slots 210₁ and 210₂, the meeting scheduling application 106 may generate a time slot 112₁ that is located adjacent to an end time of the meeting time slot 210₁. The time slot 112₁ may have been calculated to be 15 minutes based on the average historical late arrival times of the user, as described above. As a result, the meeting time slot 210₂ may be adjusted to start 15 minutes later in the user's GUI 110.

The meeting organizer of the meeting associated with the meeting time slot 210₂ may not be aware that the time slot 112₁ was created. To notify the meeting organizer, the email 300 may be automatically generated by the meeting scheduling application 106 and transmitted to an endpoint device of the meeting organizer. In one example, the email 300 may be generated and transmitted at a time the time slot 112₁ is generated and used to modify the graphical representation of the meeting time slot 210₂. In another example, the email 300 may be generated and transmitted at any time before the meeting associated with the meeting time slot 210₂ begins.

In one implementation, the email 300 may be automatically generated and transmitted to a meeting organizer by the meeting scheduling application 106. The meeting scheduling application 106 may identify the meeting organizer from information contained in the meeting time slot (e.g., one of the meeting time slots 210₁ to 210₄) and populate the “to:” address field 302 with an email address of the meeting organizer. The meeting scheduling application 106 may also populate the “subject” field 304 with the meeting at a time that is obtained from the information contained in the meeting time slot. In addition, the meeting scheduling application 106 may include text in a body 306 of the email. The text may be populated with information from the meeting time slot, such as for example, the name of the meeting organizer, a name of the user of the meeting scheduling application 106 and an amount of delay based on the time period of the time slot 112.

In one implementation, the meeting scheduling application 106 may generate and transmit emails similar to the email 300 to notify the meeting organizer that the time slot 112₁ was created. The notification may allow the meeting organizer to transmit a global message to all meeting attendees that the start time for the meeting has been moved back by 15 minutes.

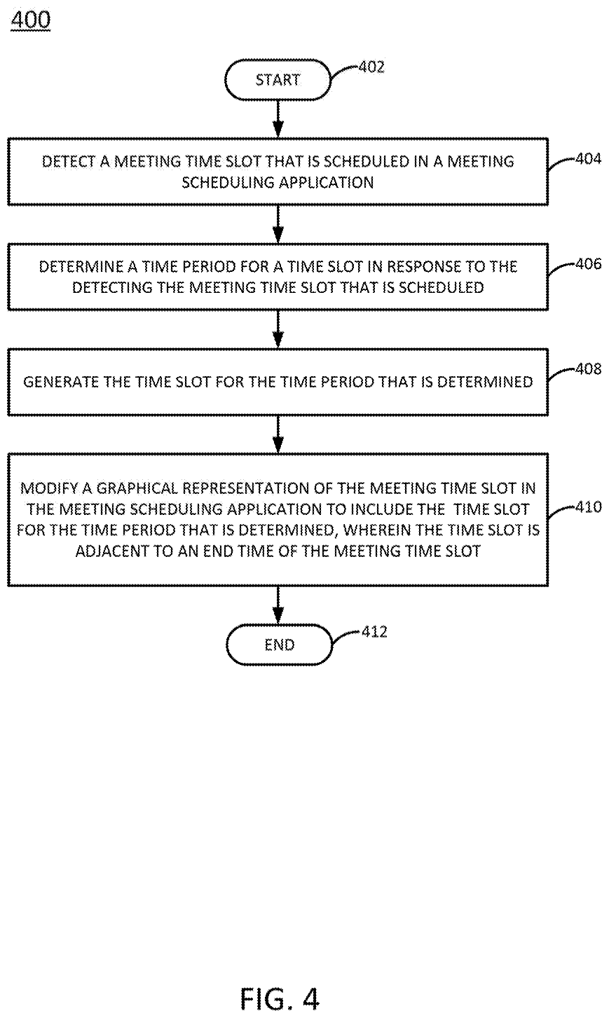

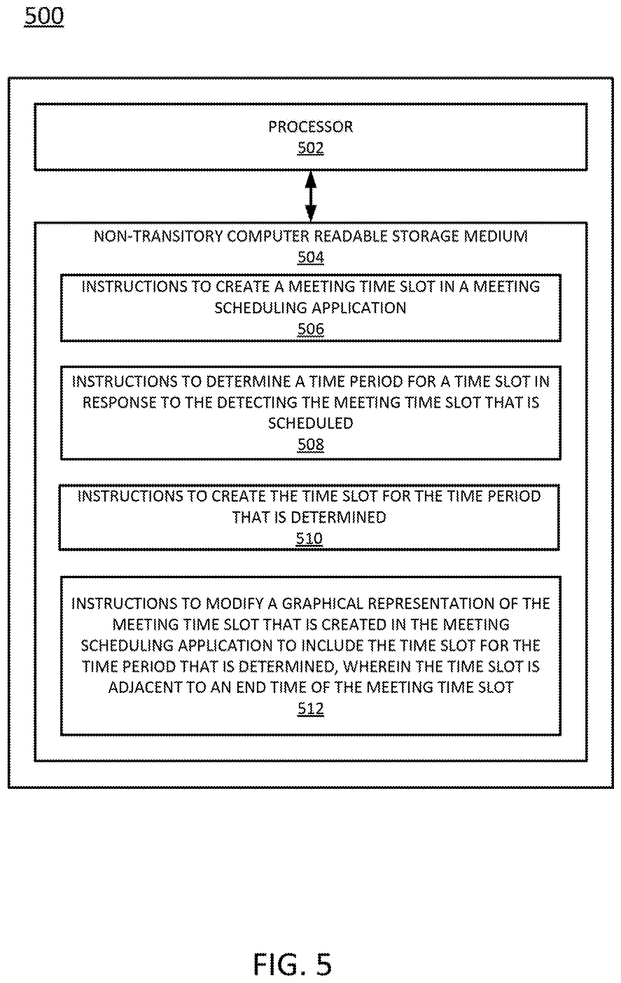

FIG. 4 illustrates a flow diagram of an example method 400 for generating a time slot in a meeting scheduling application. In one example, the method 400 may be performed by the endpoint device 100 or the apparatus 500 illustrated in FIG. 5 and discussed below.

At block 402, the method 400 begins. At block 404, the method 400 detects a meeting time slot that is scheduled in a meeting scheduling application. In one example, the meeting time slot may be scheduled immediately after or before another meeting. In other words, the meeting scheduling application may detect that meeting time slot that is scheduled is adjacent to another meeting time slot. Said another way, the meeting time slot that is scheduled may create consecutive meeting time slots.

At block 406, the method 400 determines a time period for a time slot in response to the detecting the meeting time slot that is scheduled. In one implementation, the meeting scheduling application may select a large value between an average historical late arrival time or a predefined time period (e.g., 5 minutes, 10 minutes, 15 minutes, and the like). In one example, the average historical late arrival time may be calculated based on a weighted average of the historical late arrival time to online meetings and the historical late arrival time to physical meetings, as described above.

The historical late arrival time to online meetings may be logged by the meeting scheduling application. For example, the online meetings may use a log-in and the endpoint meeting scheduling application may track the time the user logs into the online meeting.

The historical late arrival time to physical meetings may be logged from data collected by a mobile endpoint device of the user. The mobile endpoint device may track times that a user reaches a location associated with a meeting. The times may be transmitted to the endpoint device that executes the meeting scheduling application and the meeting scheduling application may receive the times. The meeting scheduling application may then calculate the late arrival times based on the times received from the mobile endpoint device and a scheduled start time of the meeting.

At block 408, the method 400 generates the time slot for the time period that is determined. For example, the size of the time slot and how the time slot will appear in a GUI of the meeting scheduling application may be generated.

At block 410, the method 400 modifies a graphical representation of the meeting time slot in the meeting scheduling application to include the time slot for the time period that is determined, wherein the time slot is adjacent to an end time of the meeting time slot. In one example, the start times of subsequent meeting time slots after the meeting time slot is modified with the time slot may be adjusted in the GUI of the meeting scheduling application.

In one example, the meeting scheduling application may generate and transmit an email addressed to a meeting organizer when the start time of a subsequently scheduled meeting overlaps the time slot. The email may inform the meeting organizer that the employee associated with the meeting scheduling application will be late to the subsequent meeting.

The time slot may also prevent other users from subsequently scheduling a meeting with the user of the meeting scheduling application immediately after another meeting that is already scheduled. For example, an invitation to attend a proposed meeting may be received. The meeting scheduling application may determine that a time period of the proposed meeting overlaps a time slot. In response, the meeting scheduling application may generate a warning notification and transmit the warning notification to a device that origination the invitation. At block 410, the method 400 ends.

FIG. 5 illustrates an example of an apparatus 500. In one example, the apparatus 500 may be the endpoint device 100. In one example, the apparatus 500 may include a processor 502 and a non-transitory computer readable storage medium 504. The non-transitory computer readable storage medium 504 may include instructions 506, 508, 510, and 512 that when executed by the processor 502, cause the processor 502 to perform various functions.

In one example, the instructions 506 may include instructions to create a meeting time slot in a meeting scheduling application. The instructions 508 may include instructions to determine a time period for a time slot in response to the detecting the meeting time slot that is scheduled. The instructions 510 may include instructions to r create the time slot for the time period that is determined. The instructions 512 may include instructions to modify a graphical representation of the meeting time slot that is created in the meeting scheduling application to include the time slot for the time period that is determined, wherein the time slot is adjacent to an end time of the meeting time slot.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
detecting, by a processor, a meeting time slot that is scheduled in a meeting scheduling application;
determining, by the processor, a time period for a time slot in response to the detecting the meeting time slot that is scheduled;
generating, by the processor, the time slot for the time period that is determined; and
modifying, by the processor, a graphical representation of the meeting time slot in the meeting scheduling application to include the time slot for the time period that is determined, wherein the time slot is adjacent to an end time of the meeting time slot.

2. The method of claim 1, wherein the time period for the time slot comprises a predefined time period.

3. The method of claim 1, wherein the determining the time period for the time slot comprises:
logging, by the processor, historical late arrival times for online meetings;
logging, by the processor, historical late arrival times to a physical location for physical location meetings from a mobile endpoint device; and
calculating, by the processor, an average of the historical late arrival time for the online meetings and the historical late arrival times for the physical location meetings; and
setting, by the processor, the time period for the time slot as a larger value of the average or a predefined time period.

4. The method of claim 3, wherein the average is a weighted average of the historical late arrival time for the online meetings and the historical late arrival times for the physical location meetings.

5. The method of claim 1, comprising:
receiving, by the processor, an invitation to attend a proposed meeting;
determining, by the processor, that a time period of the proposed meeting overlaps the time slot;
generating, by the processor, a warning notification; and
transmitting, by the processor, the warning notification to a device that originated the invitation.

6. The method of claim 1, comprising:
determining, by the processor, that a subsequent meeting overlaps the time slot;
generating, by the processor, an email addressed to a meeting organizer of the subsequent meeting in response to the determining that the subsequent meeting overlaps the time slot, wherein the email informs the meeting organizer that an employee associated with the meeting scheduling application will be late to the subsequent meeting; and
transmitting, by the processor, the email to a device of the meeting organizer.

7. The method of claim 1, wherein the time slot is displayed as a different graphical representation than the meeting time slot.

8. A non-transitory computer readable storage medium encoded with instructions executable by a processor, the non-transitory computer-readable storage medium comprising:
instructions to create a meeting time slot in a meeting scheduling application;
instructions to determine a time period for a time slot in response to the detecting the meeting time slot that is scheduled;
instructions to create the time slot for the time period that is determined; and
instructions to modify a graphical representation of the meeting time slot that is created in the meeting scheduling application to include the time slot for the time period that is determined, wherein the time slot is adjacent to an end time of the meeting time slot.

9. The non-transitory computer readable storage medium of claim 8, wherein the time period for the time slot comprises a predefined time period.

10. The non-transitory computer readable storage medium of claim 8, wherein the instructions to determine the time period for the time slot comprises:
instructions to log historical late arrival times for online meetings;
instructions to log historical late arrival times to a physical location for physical location meetings from a mobile endpoint device; and
instructions to calculate an average of the historical late arrival time for the online meetings and the historical late arrival times for the physical location meetings; and
instructions to set the time period for the time slot as a larger value of the average or a predefined time period.

11. The non-transitory computer readable storage medium of claim 10, wherein the average is a weighted average of the historical late arrival time for the online meetings and the historical late arrival times for the physical location meetings.

12. The non-transitory computer readable storage medium of claim 8, comprising:
instructions to receive an invitation to attend a proposed meeting;
instructions to determine that a time period of the proposed meeting overlaps the time slot;
instructions to generate a warning notification; and
instructions to transmit the warning notification to a device that originated the invitation.

13. The non-transitory computer readable storage medium of claim 8, comprising:
instructions to determine that a subsequent meeting overlaps the time slot;
instructions to generate an email addressed to a meeting organizer of the subsequent meeting in response to the determining that the subsequent meeting overlaps the time slot, wherein the email informs the meeting organizer that an employee associated with the meeting scheduling application will be late to the subsequent meeting; and
instructions to transmit the email to a device of the meeting organizer.

14. An apparatus, comprising:
a processor; and
a computer readable storage medium in communication with the processor, wherein the computer readable storage medium stores instructions associated with a meeting scheduling application that is executed by the processor; and
a display in communication with the processor to display a graphical user interface (GUI) of a calendar of the meeting scheduling application, wherein each meeting time slot that is scheduled is modified with a time period associated with a time slot that is adjacent to a respective end time of the each meeting time slot.

15. The apparatus of claim 14, comprising:
a communication module to receive historical late arrival times to a physical location for physical location meetings from a mobile endpoint device, wherein the historical late arrival times for physical location meetings is averaged with historical late arrival time data for online meetings to calculate the time period for the time slot.
